(19) United States
(12) Patent Application Publication
(10) Pub. No.: US 2009/0317449 A1
(43) Pub. Date: Dec. 24, 2009

(54) ANIMAL FOOD PACKAGE WITH CHEWABLE SCOOP TO PROMOTE DENTAL HEALTH

(75) Inventor: Brett C. Titus, Parker, CO (US)

Correspondence Address: HOLLAND & HART, LLP, P.O BOX 8749, DENVER, CO, 80201, US

(73) Assignee: Brett C. Titus, Parker, CO (US)

(21) Appl. No.: 12/498,959

(22) Filed: Jul. 7, 2009

Related U.S. Application Data
(63) Continuation-in-part of application No. 11/341,971, filed on Jan. 27, 2006.

(51) Int. Cl. A23K 1/165; A61Q 11/00

(52) U.S. Cl. 424/442

(57) ABSTRACT

An edible animal food scoop formulated to promote dental health is provided. The edible animal food scoop is used to dispense animal food from a container and, typically when the container is empty, is provided to the animal for chewing or consumption. Over the time the edible food scoop is used and/or in contact with the food, the edible scoop absorbs the flavor and/or scent of the animal food to move from a first flavor and/or scent to a second flavor and/or scent associated with the animal food to entice the animal into chewing or consuming the edible food scoop. Chewing the edible animal food scoop facilitates dental health.

### CLAIM OF PRIORITY UNDER 35 U.S.C. §§ 119, 120

The present patent application is a continuation in part application of U.S. patent application Ser. No. 11/341,971, filed Jan. 27, 2006, titled the same, which is incorporated herein by reference.

### FIELD OF THE INVENTION

The present invention relates to animal food and, more particularly, to dog food scoops that are configured and formulated to facilitate cleaning the teeth of a dog, provided to a dog to be chewed regularly, and to absorb the flavor and scent of dog food to entice a dog to consume the chewable scoop by which the dog's dental health is promoted.

### BACKGROUND OF THE INVENTION

In recent years, veterinarians and pet owners have become more educated and responsible regarding dental care for their pets. Today, for example, many pets receive dental care and cleaning from veterinarians. Also, veterinarians provide and promote dental care through many products such as brushing, rinsing and the like.

Some pet owners and pets, however, do not like brushing, rinsing and the like. To accommodate these dogs, enterprising companies have developed a variety of chews and toys to promote and enhance the dental well being of pets. For example, some toys are designed with fibers to simulate in a dog the action of floss while the dog chews the toy, see for example, U.S. Pat. No. 5,215,038, titled Dog Chew Toy, issued to O'Rourke, and incorporated herein by reference. Other chews also are available. For example, U.S. Pat. No. 6,050,224, titled Therapeutic Chew Device for Cleaning Teeth and Breath of Dogs, issued to Owens, relates to a chew with activated charcoal, which is incorporated herein by reference.

Many other chews exist on the market today. Many of which provide some dental cleaning action. Even conventional rawhides provide some cleaning and other dental healthcare. One popular style of treat is marketed as GREENIES®, from S & M NuTec, LLC.

While some of these products function to clean animals teeth, they are often given infrequently as owners either remember or have access to the products. Moreover, some dogs may refuse to consume or chew the teeth cleaning products as the flavor or scent of the product is unfamiliar. Thus, it would be desirous to provide an improved teeth cleaning device.

### SUMMARY OF THE INVENTION

To attain the advantages and in accordance with the purpose of the invention, as embodied and broadly described herein, an animal dental care package is provided. The animal dental care package includes a container of animal food with an edible dispensing cup provided. The edible dispensing cup is formulated to facilitate cleaning the teeth of the animal. Moreover, the edible dispensing cup may be provided with a first flavor or scent and is used with the animal food such that over time the edible dispensing cup absorbs the flavor and/or scent of the animal food such that the edible dispensing cup has a second flavor and/or scent consistent with the animal food by the time the container of food is emptied. Primarily, however, the edible dispensing cup is formulated to promote dental health of the animal. By providing the edible dispensing cup with the container, the edible dispensing cup or scoop is given to the animal at regular intervals.

The present invention also provides methods for dental care of an animal. The method includes providing animal food in a container with an edible food scoop specifically configured to promote dental well being in the animal. The edible food scoop is provided with a first flavor and scent. The edible food scoop is used to dispense food. After dispensing food, the edible food scoop may absorb the flavor and scent of the animal food over time such that when an amount of animal food is provided to the animal, the edible food scoop has a achieved a second flavor and/or scent consistent with the animal food. The edible food scoop is then provided to the animal for consuming by the animal to promote dental health. The edible food scoop is primarily to facilitate the dental health of the animal and is designed to be provided to the animal after a selected amount of animal food is provided to facilitate dental health.

The foregoing and other features, utilities and advantages of the invention will be apparent from the following more particular description of an embodiment of the invention as illustrated in the accompanying drawings. Further, the advantages and purpose of the invention will be realized and attained by means of the elements and combinations particularly pointed out in the appended claims.

### BRIEF DESCRIPTION OF TIE DRAWINGS

The accompanying drawings, which are incorporated in and constitute a part of this specification, illustrate embodiments of the present invention, and together with the description, serve to explain the principles thereof. Like items in the drawings are referred to using the same numerical reference.

FIG. 1 shows a perspective view of an edible animal food scoop in a container of animal food; and

FIG. 2 shows a flowchart illustrating a method of using an edible dog scoop.

### DETAILED DESCRIPTION

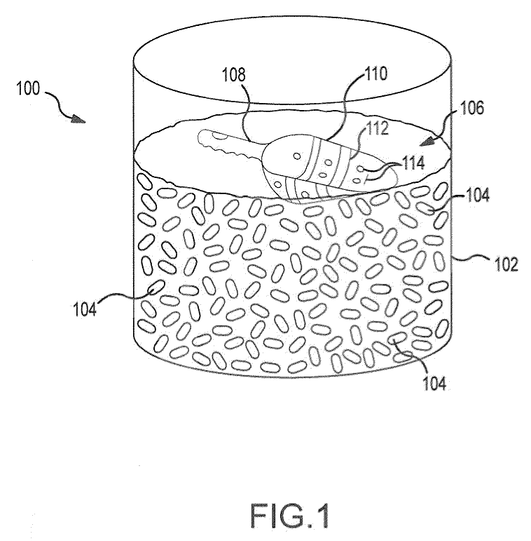

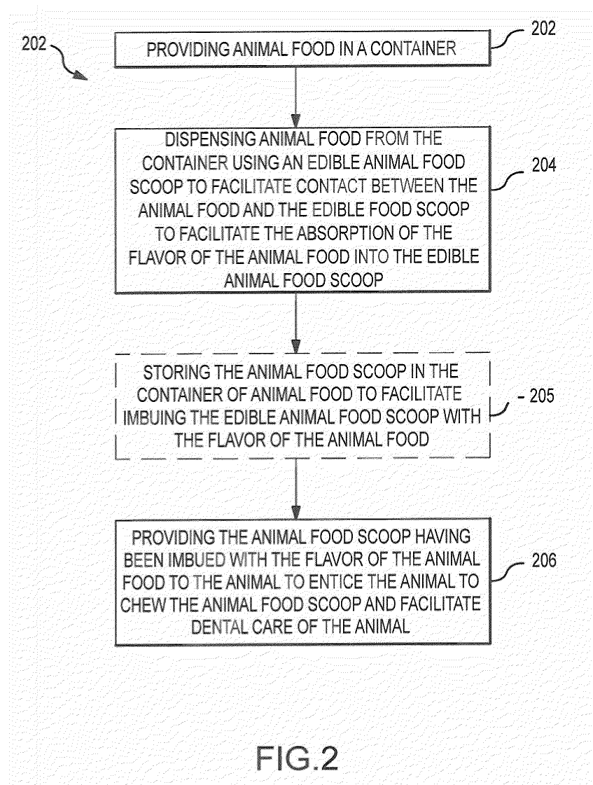

The present invention will now be explained with reference to FIGS. 1 and 2. While the present invention is particularly described with relation to dog food, one of ordinary skill in the art will understand on reading the disclosure that the present invention could apply to any animal food and animal dental care.

Referring to FIG. 1, a dental care system 100 is shown. Dental care system 100 includes a food container 102 filled with animal food 104, such as, for example, kibble for dogs. Container 102 may be a stand alone container to which food 104 is separately added from time to time or a bag of food, such as a standard bag of food available from any number of manufacturers including, for example, Hills Pet Nutrition, Inc., Ralston Purina Company, the Iams Company, or the like.

System 100 includes at least one edible dog food scoop 106. Edible dog food scoop 106 includes a grip 108 and a cup 110. Grip 108 may be a handle as shown. Further, grip 108 may be decoratively formed or shaped to facilitate holding the scoop. Other grips than a handle are possible. Cup 110 may be sized to provide a particular amount of food 104 in each scoop, such as ½ cup, 1 cup, 2 cups or the like. Alternatively, cup 110 may have indicia 112 providing graduation or the like to measure out food amounts. Providing an edible cup to dispense the food is uniquely beneficial because it removes alternative scoops from being used. Such other alternative scoops include metallic cans, fast food containers, plastics, or the like, that may have detrimental consequences to the dog or animal. Moreover, the edible food scoop is formulated of materials to facilitate teeth cleaning in the animal. In that regard, the edible dog food scoop 106 may be formulated out of (Brett—please add in the actual material you are contemplating for the scoop at this time).

While dog food scoop 106 may be provided individually, it is envisioned that a bag of dog food will be provided with one or more edible scoops 106. Scoop(s) 106 and dog food would be maintained in the bag of dog food, where the bag is container 102, or transferred to a separate container 102. The one or more scoops 106, whether provided with or independent of the food, are provided at the consumption of a selected amount of animal food such that the edible animal food scoop is provided at regular intervals to promote dental health. Providing the scoop 106 after a selected amount of food is a significant improvement over edible or chewable treats that may or may not promote dental health as dental health treats are not typically part of the regular diet of the animal. If two scoops are provided in a 15 pound bag of food, the scoops should be given when approximately 50% of the food is consumed, or about 7.5 pounds. Given the nature of the animal food, approximately 50% means anywhere from about 35% to about 65%. Similarly, if three scoops are provided, the scoops should be given out when approximately 33% of the food is consumed, or about 5 pounds. Again, given the nature of animal food, approximately 33% may mean anywhere from about 25% to about 45%. In other words, approximately should be consider as an eyeball approximately of how much animal food is left in the container.

Edible dog food scoop 106 may be formulated similar to any conventional dental cleaning products. such as, for example, rawhide and more particularly rawhides coated with enzymes, abrasives and the like such as rawhides, C.E.T.® rawhides from Virbac Corporation, GREENIES®, biscuits such as Merrick's dental treats from Merrick Pet Care, Ltd., other composite dental product and the like. The edible scoop also may contain additives 114 to help promote teeth and gum health, such as, for example, fluoride, activated charcoal, fibers, abrasives, or the like. (Brett—please indicate any additives you may be incorporating into the scoop) The additives 114 also may be facilitate absorption of the flavor and/or scent of the dog food. As used herein, flavor and/or scent may generically be referred to simply as flavor or scent. Thus, the edible dog food scoop 106 would be manufactured out of a material having a particular first flavor or scent. The first flavor or scent may be a neutral flavor and no scent. Storing the edible dog food scoop 106 with the animal food imbue the edible dog food scoop with the flavor and/or scent of the dog food. Storing the scoop should be construed to include providing a bag or container of animal food with the edible dog food scoop 106 already provided in the bag or container of animal food.

Referring now to FIG. 2, a flowchart 200 is provided illustrating a method of dental care for a dog. First, dog food is provided in a container, step 202. Next, dog food is dispensed using an edible dog food scoop, step 204. Optionally, the dog food scoop may be exposed to prolonged contact between the dog food and the edible dog food scoop to facilitate absorption of the flavor of the dog food. The edible or chewable dog food scoop is configured to promote dental health in the dog. As one of ordinary skill in the art will now recognize on reading the disclosure, using the edible dog food scoop to dispense the food accomplishes multiple tasks. One of the tasks relates to providing the edible dog food scoop with some flavor of the dog food as it comes in regular contact with the dog foods. To absorb or become imbued with the flavor/scent of the dog food, the edible dog food scoop is provided with a first flavor and through contact with the dog food, whether through contact in the feeding process or storage of the scoop with the food, absorbs the flavor and/or scent of the food. This makes it more likely that the dog will eat the scoop when it is presented to the dog. To increase the flavor absorption, optionally, the dog food scoop may be stored in the container with the food. Alternatively, the scoop may be stored external to the container. Also, using the scoop avoids the use of make shift alternative dispensing apparatuses, such as, for example, fast food containers, tin cans, soda or pop cans, and the like that many dog owners use to dispense dog food. Many of these containers contain food substances that may not be healthy for the dog, and may provide additional calories causing obesity and accelerate any dental deterioration. After dispensing dog food, the edible dog food scoop is provided to the dog for consumption (or at least chewing if the animal is not allowed to eat the scoop) to facilitate teeth cleaning and other dental care, step 206. It is envisioned the scoop will be provided as a treat when the container of food is empty. The dog owner will be provided a new edible scoop when a new container of food is purchased. In some instances, such as, for example, large bags of food, several scoops may be provided in a single container so the scoops can be given more frequently than once a container. The number of scoops could be provided so the scoops can be given out at predetermined intervals, such as, for example, a bag of food may container 3 scoops so a scoop can be provided as a treat to clean teeth when ⅓ of the bag of food is finished. Although providing the scoop can be done whenever desired.

While the invention has been particularly shown and described with reference to some embodiments thereof, it will be understood by those skilled in the art that various other changes in the form and details may be made without departing from the spirit and scope of the invention.

1. A method of dental care for animals comprising the steps of:
obtaining an edible food scoop having a first flavor to dispense food from a container of animal food to feed an animal;
dispensing animal food from the container of animal food to the animal using the provided edible food scoop such that the edible food scoop is in contact with the animal food stored in the container;
imbuing the animal food scoop with the flavor of the animal food as it is in contact with the animal food such that the animal food scoop acquires a second flavor different than the first flavor; and
feeding the animal the edible food scoop, wherein the animal is enticed to chew the edible food scoop because it has acquired the second flavor and chewing the edible food scoop promotes the dental health of the animal.

2. The method of claim 1, wherein the container is a bag of dog food and the edible food scoop is provided in the bag of dog food.

3. The method of claim 1, further comprising the step of:
storing the edible food scoop in the container of animal food; and
wherein the step of imbuing comprises absorbing the flavor of the animal food into the edible food scoop using additives.

4. An animal dental care system, the system comprising:
a container;
animal food contained in the container; and
an edible animal food scoop formulated to promote dental health, wherein the edible animal food scoop initially has a first flavor and acquires a second flavor through contact with the animal food such that the edible animal food scoop in imbued with the flavor of the animal food, and wherein providing the edible animal food scoop having the second flavor induces an animal to chew the animal and promote the dental health of the animal.

5. The system of claim 4, wherein the container is a bag of animal food.

6. The system of claim 5, wherein the edible animal food scoop is packaged with the bag of animal food.

7. The system of claim 6, wherein the edible animal food scoop is packaged internal to the bag of animal food and in contact with the animal food.

8. The system of claim 4, wherein the animal food is dog food.

9. The system of claim 8, wherein the edible animal food scoop is an edible dog food scoop comprising a dog chew, and the dog chew is selected from a group of chews consisting of: rawhides, biscuits, and composites.

10. The system of claim 4, wherein the edible animal food scoop comprises additive to promote dental health and facilitate the absorption of the flavor of the animal food.

11. The system of claim 10, wherein the additives are selected from the group of additives consisting of: abrasives, fluorides, and enzymes.

12. The system of claim 4, wherein the edible animal food scoop comprises a cup and a handle.

13. The system of claim 4, wherein the edible animal food scoop comprises a cup of a selected size to measure out a quantity of animal food.

14. The system of claim 13, wherein the size is selected from a group of sizes consisting of: ¼ cup, ⅓ cup, ½ cup, ⅔ cup, ¾ cup, 1 cup, 1.25 cups, 1.3 cups, 1.5 cups, 1.6 cups, 1.75 cups, 2 cups, 2.25 cups, 2.3 cups, 2.5 cups, 2.6 cups, 3 cups, 3.25 cups, 3.3 cups, 3.5 cups, 3.6 cups, 3.75 cups, and 4 cups.

15. The system of claim 4, wherein the edible animal food scoop comprises indicia to facilitate dispensing a determinable amount of animal food.

16. The system of claim 15, wherein the indicia designate amounts of food including ¼ cup, ⅓ cup, ½ cup, ⅔ cup, ¾ cup, 1 cup, 1.25 cups, 1.3 cups, 1.5 cups, 1.6 cups, 1.75 cups, 2 cups, 2.25 cups, 2.3 cups, 2.5 cups, 2.6 cups, 3 cups, 3.25 cups, 3.3 cups, 3.5 cups, 3.6 cups, 3.75 cups, and 4 cups.

17. An edible animal food scoop having a first flavor and to promote dental health in the animal, the edible animal food scoop comprising:
a grip to facilitate using the food scoop to dispense animal food from a container of animal food;
a cup attached to the grip, the cup to dispense an amount of animal food from the container of animal food;
at least one of the grip and the cup containing additives to absorb the flavor of the animal food such that the edible animal food scoop in imbued with a second flavor through contact with the animal food different than the first flavor; and
the edible animal food scoop is formulated to absorb the flavor of the dispensed animal food and to promote dental health, wherein providing the edible animal food scoop to the animal for consumption promotes the dental health of the animal.

18. The edible animal food scoop of claim 17, wherein the edible animal food scoop is an edible dog food scoop comprising a dog chew, and the dog chew is selected from a group of chews consisting of: rawhides biscuits, and composites.

19. The edible animal food scoop of claim 17, wherein the edible animal food scoop comprises additive to promote dental health.

20. The edible animal food scoop of claim 19, wherein the additives are selected from the group of additives consisting of: abrasives, fluorides, and enzymes.
